(19) United States
(12) Patent Application Publication
(10) Pub. No.: US 2010/0015462 A1
(43) Pub. Date: Jan. 21, 2010

(54) METALLIC NANOPARTICLE SHIELDING STRUCTURE AND METHODS THEREOF

(76) Inventors: Gregory Jablonski, Yardley, PA (US); Michael Mastropietro, Bridgewater, NJ (US); Christopher Wargo, Somerset, NJ (US)

Correspondence Address: CHOATE, HALL & STEWART LLP, TWO INTERNATIONAL PLACE, BOSTON, MA, 02110, US

(21) Appl. No.: 12/501,440

(22) Filed: Jul. 12, 2009

Related U.S. Application Data
(63) Continuation-in-part of application No. 12/039,896, filed on Feb. 29, 2008.
(60) Provisional application No. 61/080,245, filed on Jul. 12, 2008.

(51) Int. Cl. B32B 15/02; B32B 3/00; B22F 7/04

(52) U.S. Cl. 428/553; 428/208; 419/9

(57) ABSTRACT

A metallic nanoparticle shielding structure derived from a substrate having metallic nanoparticles deposited thereon in either a pattern or a coating. The pattern can comprise one or more marks that have a width of 20 to 40 micrometers and that can overlap one another. The metallic nanoparticles can be heated at a temperature less than 110 degrees Celsius for a period of time less than 90 seconds. In some embodiments, the metallic nanoparticle shielding structure can be applied to liquid crystal displays, polyester substrates, polycarbonate substrates, or any other suitable substrate.

### RELATED APPLICATIONS

This U.S. patent application claims priority to and is a continuation-in-part of U.S. patent application Ser. No. 12/039,896, filed on Feb. 29, 2008; and this U.S. patent application claims priority to U.S. Provisional Patent Application Ser. No. 61/080,245 filed on Jul. 12, 2008. The disclosure of each of the above-mentioned applications is considered part of the disclosure of this application and is herein incorporated by reference in its entirety.

### FIELD OF THE DISCLOSURE

This application relates generally to shielding. In particular, this application relates to nanoparticle shielding structures.

### BACKGROUND OF THE DISCLOSURE

In some instances, metallic nanoparticles can be used in applications where metal flakes are typically used. The metal flake typically used can be irregularly shaped metal flake that often is combined with a solvent to form a metal flake formulation. Metal flake can be used in shielding applications to provide electromagnetic interference (“EMI”) and radio frequency interference (“RFI”) shielding. The metal flake can be formulated with adhesion promoters and other additives in a solvent. The metal flake formulation can then be sprayed or otherwise applied to the plastic housing of devices such as mobile phones to create a shield.

Some applications of metal flake shielding include using the metal flake to create anti-static bags which can then be used protect electronic devices placed in the anti-static bags. Anti-static bags can be prepared by vapor depositing aluminum onto a substrate such as polypropylene or polyethylene that is subsequently fabricated into a bag that can be sealed. Such bags may not be able to be “hard creased,” wherein “hard creased” means folding the bag to create a crease. “Hard creasing” a typical aluminum-based anti-static bag can result in breakage of the aluminum surface thereby creating a “hot spot” of high resistance such that the bag can no longer protect the bag contents from EMI/RFI radiation. Furthermore, bags coated with aluminum are typically substantially opaque and so are not transparent enough to view the contents within the bag.

Metal flakes can establish a conductive pathway by incidental contact; however the points of contact between each flake are not continuous and can be highly resistive thereby introducing impurity into the system. Metal flake is typically coupled with a solvent to create a metallic flake formulation and can coalesce into a metallic structure only when cured at a high temperature for several minutes or more. The high temperature conditions required to form the metallic structure limits the type of substrates that can be used. Furthermore, metallic structure formed by the sintered metal flake is not continuous and therefore can comprise points of discontinuity which increase the resistance of the resulting structure. One example of a metallic structure that can be created by applying metal flake to a substrate is a shielding structure created using indium-tin-oxide. The limited availability of indium makes this shielding structure cost prohibitive and therefore an un-attractive shielding solution.

Accordingly, the above methods and applications typically do not produce continuous, highly-conductive metallic structures capable of dissipating static electricity thereby protecting items surrounded by the structures from EMI and/or RFI radiation. Furthermore, these methods typically are not formed on substrates or structures unable to tolerate the harsh processing conditions associated with metal flake shielding systems.

### SUMMARY OF THE DISCLOSURE

In its broadest reasonable interpretation, this disclosure describes methods, systems and structures for generating a metallic nanoparticle shielding structure that dissipates static electricity thereby protecting against EMI and/or RFI radiation. This disclosure describes structures and methods for creating structures that can achieve a high shielding effectiveness at a low cost. This high shielding effectiveness can be achieved by coating a substrate with the metallic nanoparticles described herein, or by depositing the metallic nanoparticles described herein in a pattern of markings small enough to be substantially invisible to the human eye, but large enough to provide significant conductivity and electrical performance. The relatively mild processing conditions, (e.g. heating the metallic nanoparticles at a low temperature for a short period of time,) required to create the metallic nanoparticle shielding structure permit batch processing and the use of a wider variety of substrates and substrate material.

In one aspect, described herein is a metallic nanoparticle shielding structure that comprises a substrate and a plurality of metallic nanoparticles deposited in a pattern on the substrate. The plurality of metallic nanoparticles and the substrate are heated to a temperature less than 110 degrees Celsius to form the metallic nanoparticle shielding structure.

In one embodiment, the metallic nanoparticles are deposited in a pattern that comprises at least two marks separated laterally by a space having a width of 100 to 300 micrometers, each mark having a characteristic predetermined length and a characteristic width of 20 to 40 micrometers.

In another embodiment, the metallic nanoparticles comprise at least one silver nanoparticle.

In yet another embodiment, the substrate comprises any one of a polyester substrate, a polycarbonate substrate, a liquid crystal display substrate, glass, silica-based substrate, metal substrate and metal oxide substrate.

The metallic nanoparticle shielding structure, in some embodiments, comprises metallic nanoparticles and a substrate that are heated for a period of time less than 90 seconds.

In some embodiments, the each metallic nanoparticle in the plurality of metallic nanoparticles has an average particle size of less than 100 nm.

In other embodiments, the metallic nanoparticle shielding structure has a sheet resistance of less than 1.5 ohms/square/mil.

The metallic nanoparticle shielding structure, in some embodiments, further results from oxidizing a plating applied to the substrate subsequent to heating the deposited metallic nanoparticles and the substrate.

The metallic nanoparticle shielding structure, in some embodiments, comprises metallic nanoparticles that are deposited in a pattern comprising a coating. In other embodiments, the metallic nanoparticle shielding structure comprises metallic nanoparticles that are deposited in a pattern comprising a plurality of lines.

In other aspects, described herein is a method for producing a metallic nanoparticle shielding structure. A plurality of metallic nanoparticles is deposited in a pattern on a substrate. The substrate and the metallic nanoparticles are then heated to a temperature less than 110 degrees Celsius to form a metallic nanoparticle shielding structure.

In some embodiments, the method further comprises applying, after heating the metallic nanoparticles and the substrate, a metallic plating to the substrate and the pattern formed by the metallic nanoparticles. The metallic plating is then oxidized to remove the metallic plating. What results, in some embodiments, from the metallic plating or other chemical treatment, is a non-metallic structure such as a sulfide that darkens the pattern formed by the cured metallic nanoparticles.

### BRIEF DESCRIPTION OF THE DRAWINGS

The summary, as well as the following detailed description, is further understood when read in conjunction with the appended drawings. For the purpose of illustrating the methods, system and structures described herein, there are shown in the drawings exemplary embodiments. These drawings, however, are not intended to limit the present disclosure to the specific methods, compositions, and devices disclosed. In addition, the drawings are not necessarily drawn to scale. In the drawings:

FIG. 1(A) depicts a transmission electron microscope (“TEM”) micrograph of one embodiment of silver nanoparticles;

FIG. 1(B) illustrates an embodiment of a scanning electron microscope (“SEM”) micrograph of a trace comprised of a composition of the metallic nanoparticles described herein cured for 1 minute at 100 degrees Celsius;

FIG. 1(C) depicts a SEM micrograph of a trace comprised of a composition of the present disclosure cured for 3 minutes at 85 degrees Celsius;

FIG. 2 illustrate an embodiment of a portion of metallic nanoparticles deposited in a pattern; and

FIG. 3 illustrates an embodiment of a method of generating a metallic shielding structure.

### DETAILED DESCRIPTION

The methods, systems and apparatus described herein are not limited to the specific devices, methods, applications, conditions or parameters described and/or shown herein. Furthermore, the terminology used herein is for the purpose of describing particular embodiments by way of example only and is intended to describe not limit. Also, as used in the specification including the appended claims, the singular forms “a,” “an,” and “the” include the plural, and reference to a particular numerical value includes at least that particular value, unless the context clearly dictates otherwise. The term “plurality”, as used herein, means one or more. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the methods, systems and structures described herein are described in the context of separate embodiments, and may be provided in any combination or sub-combination of the embodiments described herein. Furthermore, any reference to values stated in ranges includes each and every value within that range.

### Terms

As used herein, “mil” means 1/1000 of an inch. 1 mil is also equivalent to 25.4 micrometers.

As used herein, “sheet resistance” means the electrical resistance divided by the number of squares.

As used herein, “square” means the length of a film or layer divided by the length of the film or layer.

As used herein, the term “mohms” refers to milli ohms, or 1/1000.sup.th ohm.

As used herein, the term “aqueous” means containing water. In some embodiments, the term “aqueous” refers to a solution comprised substantially entirely of water. In other embodiments, the term “aqueous” can refer to a solution comprised substantially entirely of water and containing limited amounts of additives that adjust either the rheology or adhesiveness of the solution.

As used herein, the term “bonding” means covalently bonding, ionically bonding, hydrogen bonding, coordinate bonding, and the like.

As used herein, the term “tail” means a straight, branched, or cyclic chain of carbon atoms, wherein the chain may be aliphatic, and wherein the chain may have one or more additional groups bound to one or more of its member carbon atoms. An example would be a chain of aliphatic carbon atoms with an alcohol group attached to one of the chain members.

As used herein, the term “heteroatomic head group” means a group including at least one atom wherein at least one atom within the group is atom other than carbon. Examples include nitrogen, sulfur, or oxygen.

As used herein, the term “cohesive” means united as a single entity and resisting separation.

As used herein, the term “complexing” means forming coordinating bonds with a metal atom or ion.

As used herein, the term “ligand” means a molecule or a molecular group that binds to another chemical entity to form a larger complex. Examples include a molecular group that becomes bound to a metal or metal ion by a coordinate covalent bond through donating electrons from a lone electron pair of the ligand into an empty metal electron orbital.

As used herein, the term “agglomeration” means two or more particles reversibly clustered together, wherein the surfaces of the particles do not come into contact with one another.

As used herein, the term “floc” means two or more particles reversibly clustered together, wherein the surfaces of the particles do not come into contact with one another.

As used herein, the term “bulk resistivity” means the inherent resistivity of a material that makes up a specified object. For example, the bulk resistivity of an ingot made of silver would be the inherent conductivity of silver. As another example, the bulk resistivity of an ingot made of an alloy comprising silver and gold would be the inherent conductivity of the silver and gold alloy.

As used herein, the terms “aggregate”, “aggregation”, and similar forms mean a unified structure comprised of two or more particles irreversibly fused, connected, or necked together.

As used herein, “corresponding metal” means the metal or metals that comprise an object or objects.

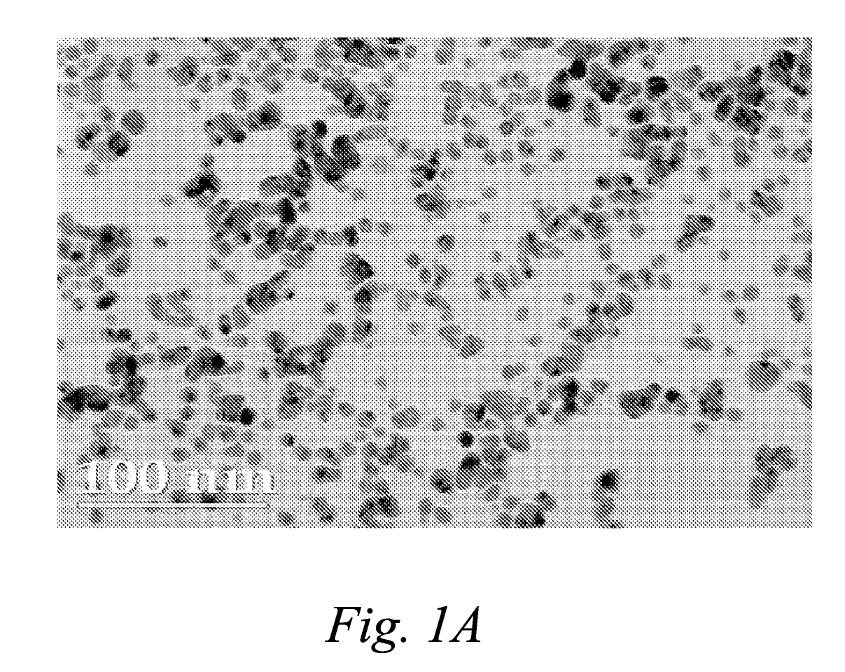

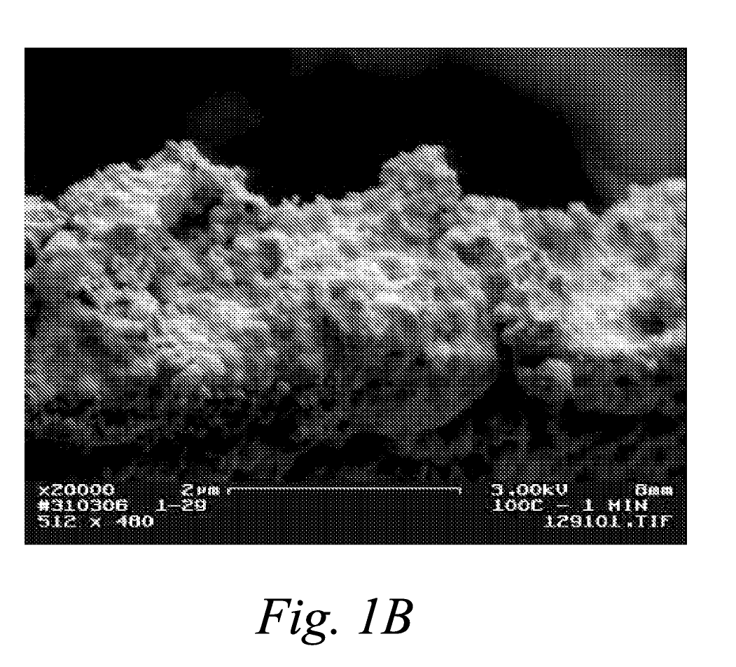

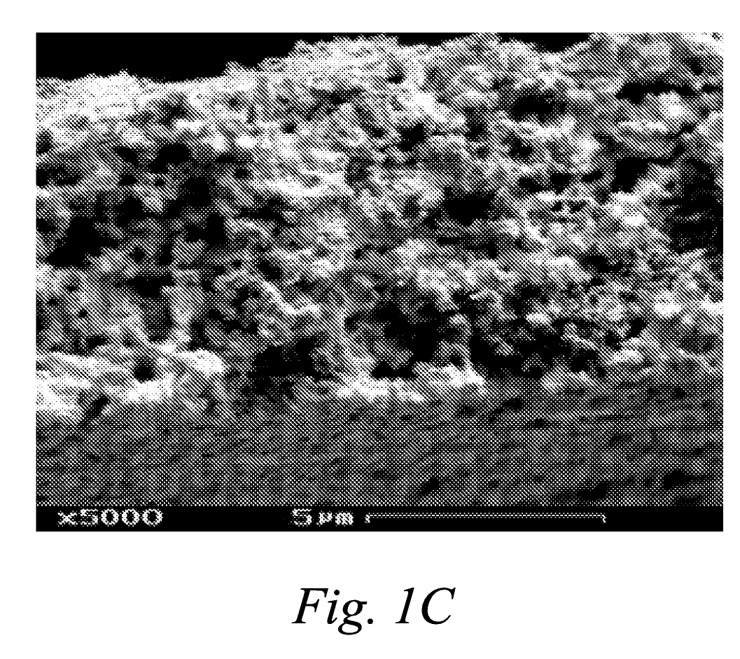

Illustrated in FIGS. 1A-1C are metallic nanoparticles, such as the metallic nanoparticles that can be used to create cohesive metallic shielding structures. In one embodiment, the metallic nanoparticles can comprise at least one silver nanoparticle. In other embodiments, the metallic nanoparticles can comprise any combination of the following compositions or elements: copper; gold, zinc; cadmium; palladium; iridium; ruthenium; osmium; rhodium; platinum; aluminum; iron; nickel; cobalt; indium; silver oxide; copper oxide; gold oxide; zinc oxide; cadmium oxide; palladium oxide; iridium oxide; ruthenium oxide; osmium oxide; rhodium oxide; platinum oxide; iron oxide; nickel oxide; cobalt oxide; indium oxide; or any other conductive metal or metal oxide suitable for the methods and structures described herein.

The metallic nanoparticles, in some embodiments, can have an average particle size of less than about 100 nm. In other embodiments, the metallic nanoparticles can have an average particle size of less than about 50 nm. In still other embodiments, the metallic nanoparticles can have an average particle size within the range of 50 nm to 75 nm, while in other embodiments the nanoparticles can have an average particle size within the range of 75 nm to 100 nm. The metallic nanoparticles, in some embodiments, can have an average particle size within the range of 15 nm to 50 nm. While in some embodiments, the metallic nanoparticles can have an average particle size within the range of 30 nm to 50 nm.

The metallic nanoparticles, in one embodiment, can have an average cross-sectional dimension in a range of about 1 nm to about 100 nm. These metallic nanoparticles, in some embodiments, can comprise at least one ligand bound to its surface, where the ligand can include a heteroatom head group bound to the nanoparticle surface and a tail bound to the heteroatom head group.

In some embodiments, the metallic nanoparticles can be substantially spherical in shape, while in other embodiments the nanoparticles can be any of the following shapes: kidney-shaped; circular; triangular; rectangular; trapezoidal; typaniform; or any other suitable shape. In some embodiments, each nanoparticle within a plurality or population of metallic nanoparticles can have a substantially uniform shape. In other embodiments, each nanoparticle within a plurality or population of metallic nanoparticles can have a substantially uniform size.

In some embodiments, a plurality of nanoparticles or nanoparticle population can include particle agglomerates that include two or more individual nanoparticles. In other embodiments, a plurality of nanoparticles can include a nanoparticle floc that includes two or more individual nanoparticles. In other embodiments, a plurality of nanoparticles can include any combination of particle agglomerate and a nanoparticle floc.

In some embodiments, the ratio by weight of the population of individual metallic nanoparticles to particle agglomerate can be within a range of about 1:99 to 99:1. In other embodiments, the ratio, by weight, of the population of individual metallic nanoparticles to particle floe can be in the range of from about 1:99 to 99:1. A nanoparticle agglomerate or floe can have an average cross-sectional dimension in the range of from about 100 nm to about 10,000 nm. Individual metallic nanoparticles within the nanoparticle agglomerate or floc can comprise any of the above-described compositions or elements. In particular, the individual metallic nanoparticles can comprise silver nanoparticles. In other embodiments, the individual nanoparticles can comprise any combination of the following: silver, copper, gold, zinc, cadmium, palladium, iridium, ruthenium, osmium, aluminum, rhodium, platinum, iron, nickel, cobalt, indium, silver oxide, copper oxide, gold oxide, zinc oxide, cadmium oxide, palladium oxide, iridium oxide, ruthenium oxide, osmium oxide, aluminum oxide, rhodium oxide, platinum oxide, iron oxide, nickel oxide, cobalt oxide, and indium oxide.

In some embodiments, the metallic nanoparticles can be present within a composition in the range of from about 0.5 wt % to about 70 wt %. Ligand can be present in the range of from about 0.5 wt % to about 75 wt %, and the medium is present in the range of from about 30 to about 98 wt %. The medium, in some embodiments, is an aqueous solution comprising water.

A composition can be formed from the metallic nanoparticles and an aqueous solution such as any of the aqueous solutions described herein. In some embodiments, the composition can be capable of forming a cohesive structure of less than about 10 micrometers in thickness formed when the metallic nanoparticles are heated at a low temperature. This low temperature, in some embodiments, can be a temperature of less than about 140 degrees Celsius. To create the cohesive structure, the metallic nanoparticles are heated at the low temperature for a period of time less than about 60 seconds. The resulting cohesive shielding structure, in some embodiments, can have a resistivity in the range of from about 2 times to about 15 times the bulk resistivity of the corresponding metal used in the metallic nanoparticle composition.

A continuous network film is created once the metallic nanoparticles are heated at a low temperature. The low temperature can be a temperature less than about 140 degrees Celsius. This film can form any number of shapes, marks, lines, figures and can occupy an area having various dimensions and configurations. In some embodiments, the nanoparticles, when heated, do not create a monolayer but rather an agglomerate of nanoparticles. Furthermore, the nanoparticles, when heated, can form a continuous porous network of cured nanoparticles. The network, in some embodiments, can be referred to as a matrix, network, web, grid or pattern of cured metallic nanoparticles.

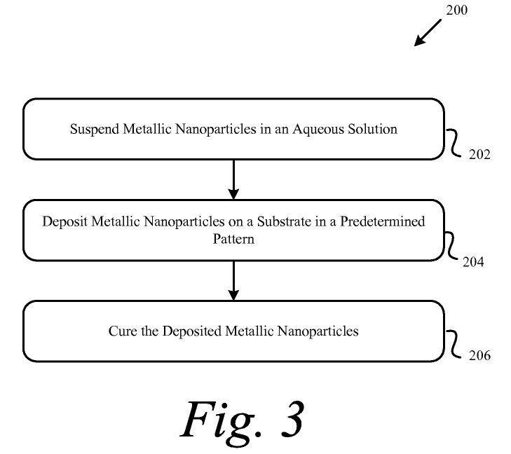

Illustrated in FIG. 3 is an embodiment of a method 200 for depositing metallic nanoparticles on a substrate to create a shielding structure. In one embodiment, the metallic nanoparticles are suspended in an aqueous solution (Step 202). The metallic nanoparticles are then deposited on a substrate in a predetermined pattern (Step 204) and the deposited metallic nanoparticles are cured (Step 206).

Further referring to FIG. 3, and in more detail, in one embodiment the metallic nanoparticles can be suspended in any suitable aqueous solution (Step 202). The metallic nanoparticles, in one embodiment, can be any metallic nanoparticle. In other embodiments, the metallic nanoparticles can be any of the metallic nanoparticles described herein. In still other embodiments, the metallic nanoparticles can be any of the metallic nanoparticles comprising metallic nanoparticle-based inks manufactured by PCHEM ASSOCIATES of Bensalem, Pa.

Preferably the aqueous solution is comprised substantially entirely of water. In some embodiments, the aqueous solution can be an aqueous medium capable of solvating metallic salts in a range of from about 10 grams/liter to about 600 grams/liter. Thus, in some embodiments comprise additives that may be used to adjust the rheology or viscosity of the aqueous solution, or to adjust or otherwise modify the adhesive properties of the aqueous solution to improve or reduce adhesion of the metallic nanoparticles to the substrate. In some embodiments, any of the following compositions can be added to the aqueous solution: adhesives; rheology modifiers; thickeners; or any combination of these compositions.

In some embodiments, the rheology of the solution can be adjusted by adding different compounds to achieve different viscosities. In one embodiment, a gelatin can be added to the aqueous solution to adjust the viscosity of the aqueous solution. Additional compounds that may be added to adjust the viscosity of the aqueous solution are any of the following: metal oxide suspensions; salt solutions; salt solutions (e.g. KCl or NaCl); buffers (e.g. Na2CO3/NaHCO3, Na2HPO4/NaH2PO4); alcohols (e.g. methanol or ethanol); hydrogels; polymeric additives; or other liquid or non liquid additives.

Different binders can also be added to the aqueous solution to adjust the adhesive properties of the aqueous solution. These binders, in some embodiments, can include any of the following compositions: epoxies; urethanes; acrylics; latex systems; cyanoacrylates; epoxy-based compounds; dental resin sealants; dental resin cements; glass ionomer cements; poly(methyl methacrylate); gelatin-resorcinol-formaldehyde glues; zinc phosphate; magnesium phosphate and other phosphate based cements; zinc carboxylate; and other silica-based coupling agents.

The metallic nanoparticles are then deposited on the substrate in a predetermined or random pattern (Step 204). In some embodiments, the substrate can comprise a polyester or polycarbonate. In other embodiments, the substrate can comprise any combination of the following: glass; silica-based substrates; poly(desaminotyrosyltyrosine(ethyl ester)carbonate) (PolyDTE carbonates); poly(desaminotyrosyltyrosine carbonates) (PolyDT carbonates); polylactides; polycaprolactones; polyglycolides; polyglyconates; polyhydroxybutyrates; polyhydroxyvalerates; poly(arylates); poly(anhydrides); poly(hydroxy acids); poly(ortho esters); poly(alkylene oxides); poly(propylene glycol-co fumaric acids); poly(propylene fumerates); polyoxamers; polyamino acids; polyacetals; poly(dioxanones); poly(vinyl pyrrolidones); polycyanoacrylates; polysaccharides; polystyrenes; polysulfones; polyureas; poly(vinyl alcohols); polyamides; poly(tetrafluoroethylenes), and expanded polytetrafluroethylenes (ePTFE); poly(ethylene vinyl acetates); polypropylenes; polyacrylates; non-biodegradable polycyanoacrylates; polyurethanes; polymethacrylates; poly(methyl methacrylates); poly(vinyl chlorides); polyethylenes, including ultra high molecular weight); polypyrroles; polyanilines; polythiophenes; poly(ethylene oxides); copolymers of any combination: vinylpyrrolidone, methacrylamide, lactide-glycolide and hydrogel N-vinylimidazole; metal or metal oxides; liquid crystal surfaces; or any other substrate suitable for use in the methods, systems and structures described herein. One embodiment includes a substrate comprised of any one of the following materials: an engineered polymer (PET, PEN, PVC, polycarbonate, polyamide, et. al.); a paper based material (coated, uncoated, board stock, corrugated, engineered paper, et. al.); a ceramic material; a glass material; a silicon based material; or any other material able to receive a metallic ink deposited thereon. The substrate, in some embodiments, can be a material having a characteristic such that one side of the substrate is static dissipative while the other side is able to receive a metallic ink deposit.

In still other embodiments, the substrate can comprise any of the following types of devices or equipments: a television screen; a computer screen; a cell phone casing or screen; a computer casing; anti-static bags; electrical component manufacturing equipment; or any other device, machine or element requiring EMI or RF shielding.

In some embodiments, the substrate can be referred to as the print surface on which the metallic nanoparticles are printed, i.e. deposited. The clarity of the substrate can be varied by etching the surface of the substrate with a chemical solution suitable for etching. In some embodiments, the substrate can comprise a film or resin that can increase or decrease the toughness and/or the clarity of the substrate. The film or resin, in some embodiments, can promote the adhesion of the metallic nanoparticles to the substrate. The optical clarity of the substrate, in some embodiments, can affect the optical clarity of resulting metallic nanoparticle shielding structures. In some embodiments the method 200 can comprise a further step of selecting a substrate having an optimal optical clarity.

The nanoparticles can be deposited on a substrate to a thickness of less than about 150 microns, or to a thickness of less than about 50 microns, or to a thickness of less than about 20 microns. In some embodiments, the composition comprising at least one metallic nanoparticle in an aqueous medium is deposited to a thickness of less than about 10 microns, less than about 5 microns, less than about 3 microns, to a thickness of less than about 2 microns or even to a thickness of less than about 1 micron. In one preferable embodiment, the metallic nanoparticle shielding structure can comprise a metallic nanoparticle deposition having a thickness within the range of 0.1 microns to 50 microns. In other embodiments, the deposition can have a thickness less than 0.1 microns. In still other embodiments, the deposition can have a thickness between 0.1 microns and 3 microns, a thickness between 3 microns and 5 microns, or a thickness between 5 microns and 10 microns. In still other embodiments, the deposition can have a thickness less than 20 microns, 15 microns, 10 microns or 5 microns.

Depositing the metallic nanoparticles onto the substrate, in some embodiments, can comprise coating the substrate with a formulation comprising the metallic nanoparticles and any aqueous medium described herein. The substrate can be coated using any of the following methods: spray coating; curtain coating; dip coating; spread coating; roller coating; spin coating; blade coating; wire rod coating; or any other type of physical coating. In some embodiments, the substrate can be chemically coated via a redox reaction, electrodeposition or vapor phase deposition. Other spray coating methods comprise any method of liquid or powder deposition able to deposit a coating of metallic conductive ink onto a substrate. In some embodiments, the coating can cover substantially the entire surface of the substrate. In other embodiments, the coating can comprise a monolayer covering substantially the entire surface of the substrate.

Various aspects of the coating method such as the amount of time the coating applied to each particular area of the substrate, the volume of solution sprayed during a period of time, the angle at which the solution is sprayed onto the substrate, the distance between the mechanism used to spray the coating and the substrate, and the mechanism used to spray the coating, can be varied to achieve varying levels of coating thickness. Thus, these variables can, in some embodiments, be varied and controlled to achieve a predetermined coating thickness and pattern of relief. For example, the coating can be thicker in some areas of the substrate than in other areas of the substrate. This varying thickness can generate a random or predetermined relief pattern on the surface of the substrate.

Depositing the metallic nanoparticles on the substrate, in some embodiments, can comprise printing the metallic nanoparticles onto the substrate. The method of printing can comprise any of the following print methods: flexography; screen printing; rotogravure printing; lithographic printing; intaglio printing; relief printing; laser printing; pad printing; ink-jet printing; and any other printing method or technique able to deposit a conductive ink onto a substrate using one or more printing methods. In embodiments where flexography is used to print the metallic nanoparticles onto the substrate, ink comprising the metallic nanoparticles can be transferred from a print plate to a substrate. In embodiments where gravure printing is used, ink comprising the metallic nanoparticles is transferred from an engraved cylinder onto a substrate. In still other embodiments where offset lithography printing is used, ink comprising the metallic nanoparticles are deposited onto a metal plate typically etched or laser ablated with a predetermined pattern.

The metallic nanoparticles can be deposited in any of the following patterns: a continuous film; a wire mesh pattern; a series of dots or marks; a series of lines; randomly placed markings; a series of dots and lines; a series of dots, lines and other markings; or any other pattern of deposition able to achieve the methods and structures described herein. The markings can be of any shape, size and can be placed along the substrate in any ordered or random pattern.

In some embodiments, the metallic nanoparticles can be deposited in a pattern comprising a plurality of concentric circles, ellipses, ovals, triangles, rectangles, squares, trapezoids, or any other enclosed shape. In other embodiments, the metallic nanoparticles can be deposited in a pattern of random markings that include a plurality of lines, marks, dots or other shapes ordered in a random pattern over the surface of the substrate. In some embodiments, the pattern markings include marks deposited substantially parallel to one another. In other embodiments, the pattern markings include marks deposited substantially perpendicular to one another. In still other embodiments, the pattern markings include marks deposited at a predetermined angle to one another. The predetermined angle can be uniformly the same for each deposited mark, or the predetermined angle can vary from mark to mark. In some embodiments, the marks comprise substantially straight lines. In other embodiments, the marks comprise substantially curved lines. In still other embodiments, the marks comprise lines having both curved line segments and straight line segments.

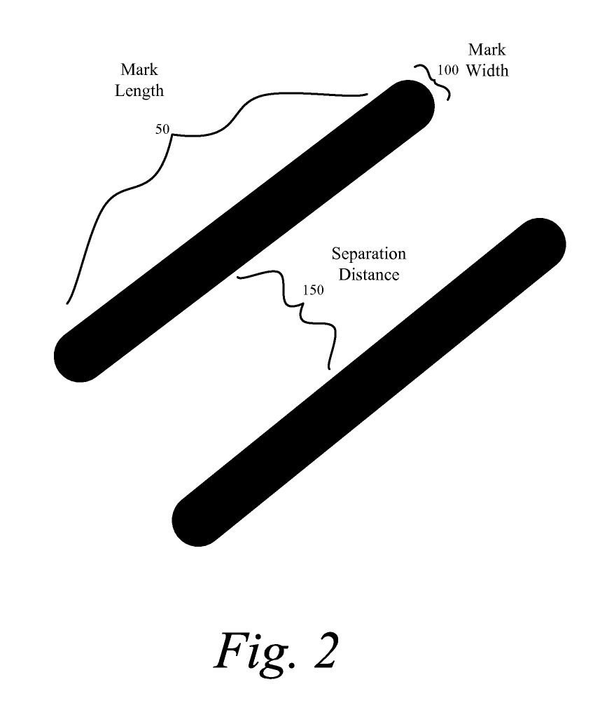

Illustrated in FIG. 2 is one embodiment of a section of a pattern of printed metallic nanoparticles. The markings are spaced apart according to a spacing distance 150, and each marking has a characteristic length 50 and width 100.

The characteristic width 100 of each marking can, in some embodiments, be 20 micrometers. In one embodiment, the width 100 can be less than 5 microns. The characteristic width 100, in some embodiments, can be a value within the range of 5 microns to 50 microns. Some embodiments include a width 100 within a range of 10 microns to 20 microns, while still other embodiments include a width 100 within a range of 5 microns to 10 microns. The width 100, in some embodiments, can be a value within a range of 10 microns to 15 microns, or within a range of 15 microns to 20 microns. In other embodiments, the characteristic width 100 can be within a range of 20 micrometers to 40 micrometers. Still other embodiments include a characteristic width 100 less than 20 micrometers, while other embodiments include a characteristic width 100 greater than 40 micrometers. The characteristic width 100, in some embodiments, can be within a range of 20 micrometers to 30 micrometers. In other embodiments, the characteristic width 100 can be within a range of 25 micrometers to 35 micrometers. While in still other embodiments, the characteristic width 100 can be within a range of 30 micrometers to 40 micrometers. In one embodiment, each mark within the pattern has substantially the same width such that a first mark in the pattern has a first width that is substantially the same as the second width of a second mark in the pattern. In other embodiments, each mark within the pattern can have a varying width such that a first mark in the pattern has a first width that is different from a second width of a second mark in the pattern.

The characteristic length 50, in some embodiments, can be any predetermined length. In one embodiment, the length 50 can span the entire length or side of a substrate. In other embodiments, the characteristic length 50 can be less than 20 micrometers, while in other embodiments the characteristic length 50 can be greater than 40 micrometers. The characteristic length 50, in one embodiment, can be within a range of 20 micrometers to 40 micrometers. The characteristic length 50, in some embodiments, can be within a range of 20 micrometers to 30 micrometers. In other embodiments, the characteristic length 50 can be within a range of 25 micrometers to 35 micrometers. While in still other embodiments, the characteristic length 50 can be within a range of 30 micrometers to 40 micrometers. In still other embodiments, the length 50 can be substantially equal to the width 100 of the mark. In one embodiment, each mark within the pattern has substantially the same length such that a first mark in the pattern has a first length that is substantially the same as the second length of a second mark in the pattern. In other embodiments, each mark within the pattern can have a varying length such that a first mark in the pattern has a first length that is different from a second length of a second mark in the pattern.

The separation distance 150, in one embodiment, can be a value within the range of 100 to 400 micrometers. In some embodiments the separation distance 150 between each marking can be less than 100 micrometers, while in other embodiments the separation distance 150 can be greater than 400 micrometers. In some embodiments, the separation distance 150 can be within a range of 100 micrometers to 200 micrometers, while in other embodiments the separation distance 150 can be within a range of 100 micrometers to 300 micrometers. In still other embodiments, the separation distance 150 can be within a range of 200 micrometers to 300 micrometers, while in other embodiments the separation distance can be within a range of 300 micrometers to 400 micrometers. In one embodiment, marks within the pattern can be spaced apart by a substantially uniform separation distance such that a first mark is spaced a first separation distance between the first mark and a second mark. This first separation distance is substantially the same as a second separation distance between the second mark and a third mark. In another embodiment, marks within the pattern can be spaced apart by substantially non-uniform separation distances such that a first mark is spaced a first separation distance between the first mark and a second mark. This first separation distance is different from a second separation distance between the second mark and a third mark.

When the metallic nanoparticles are deposited on a substrate and heated or cured to form a cohesive metallic shielding structure, the cohesive metallic shielding structure can have a sheet resistance less than about 50 mohms/square/mil. In some embodiments, the cohesive metallic shielding structure can have a sheet resistance of at least about 10 mohms/square/mil. The cohesive metallic nanoparticle shielding structure, in some embodiments, can have a sheet resistance of 1.5 ohms/square/mil. In one embodiment, the metallic nanoparticle shielding structure can have a sheet resistance in a range from 0.1 ohms/square to 0.7 ohms/square. In still other embodiments, the cohesive metallic shielding structure can have a sheet resistance of less than 1 kohm/square/mil.

The conductivity of the metallic shielding structure can, in some embodiments, correlate to the sheet resistance of the metallic shielding structure. For example, the lower the sheet resistance, the greater the conductivity. In some cases, there is a minimum sheet resistance at which the conductivity of the metallic shielding structure can no longer be improved. Any further lowering of the sheet resistance to a value less than this minimum sheet resistance may not result in an increase in the conductivity of the metallic shielding structure. In this instance, additional metal can be added to the metallic shielding structure to further increase the conductivity of the metallic shielding structure. The addition of the metal can be accomplished by increasing the percentage of metallic nanoparticles in the metallic nanoparticle composition, or any other suitable method for increasing the amount of metal deposited on the substrate.

Further referring to FIG. 3, once the metallic nanoparticles are deposited in a predetermined pattern (Step 204), the deposited nanoparticles can be cured or heated (Step 206). In some embodiments, the deposited metallic nanoparticles can be cured or heated at a temperature less than about 140 degrees Celsius. In other embodiments, the deposited metallic nanoparticles can be heated at a temperature within a range of 85 degrees Celsius to 140 degrees Celsius. In still other embodiments, the metallic nanoparticles can be heated at a temperature within a range of 95 degrees Celsius to 110 degrees Celsius. The metallic nanoparticles, in some embodiments, can be heated at a temperature slightly greater than 140 degrees Celsius.

The metallic nanoparticles can be heated continuously at a predetermined temperature such as any of those temperatures described herein, for a period of time less than approximately 90 seconds. In other embodiments, the metallic nanoparticles can be heated for a period of time within the range of 80 seconds to 2 minutes. In still other embodiments, the nanoparticles can be heated for a period of time within the range of 70 seconds to 140 seconds. In yet another embodiment, the metallic nanoparticles can be heated for a period of time within the range of 0.2 seconds to 2 minutes. The metallic nanoparticles, in one embodiment, can be heated at a first temperature for a first period of time, and at a second temperature either greater than or less than the first temperature for a second period of time.

In some embodiments, the time period during which the metallic nanoparticles are heated is proportional to the temperature at which the metallic nanoparticles are heated. In one embodiment, this relationship could be characterized as inversely proportional such that the higher the temperature, the shorter the cure time or time period during which the metallic nanoparticles are heated. For example, when the metallic nanoparticles are heated at a surface temperature (i.e. the surface temperature of the substrate) of 140 degrees Celsius, the cure time can be a time less than approximately 60 seconds. In another example, when the metallic nanoparticles are heated to a temperature within the range of 95 degrees Celsius and 110 degrees Celsius, the cure time can be a time less than approximately 120 seconds. In yet another example, when the metallic nanoparticles are heated to a temperature of 180 degrees Celsius, the cure time can be less than 10 seconds. The metallic nanoparticles can be cured, in some embodiments, for a period of time less than approximately 90 seconds for temperatures less than 100 degrees Celsius. In other embodiments, the metallic nanoparticles can be heated for a period of time within the range of 0.2 seconds to 10 minutes. In still other embodiments, the nanoparticles can be heated or cured for a period of time within the range of 2 seconds to 30 seconds for temperatures greater than 100 degrees Celsius but less than 150 degrees Celsius. In still other embodiments, the nanoparticles can be cured or heated for a period of time within the range of 0.2 seconds to 2 seconds at temperatures greater than 150 degrees Celsius but less than 200 degrees Celsius. The metallic nanoparticles, in one embodiment, can be cured or heated at a first temperature for a first period of time, and at a second temperature either greater than or less than the first temperature for a second period of time. The periods of time for each temperature are dependent on that temperature and can in some embodiments be determined based on the above-described, inversely proportional temperature/cure time relationship.

Once heated, the metallic nanoparticles can create a cohesive shielding structure having a characteristic thickness such as any of the cured nanoparticle thicknesses described herein. In other embodiments, the cohesive shielding structure can have a thickness of less than about 50 micrometers. In some embodiments, the cohesive structure has a thickness of less than about 10 microns, or less than about 5 microns. In one embodiment, the cohesive metallic shielding structure can have a density less than the density of the bulk metal. In still other embodiments, the cohesive metallic shielding structure can have a density as low as 40% of the density of the corresponding bulk metal.

In one embodiment, the method 200 can further comprise a step of plating a substrate comprising deposited, cured metallic nanoparticles with a base metal such as copper, chrome, nickel or any of their alloys. Further oxidizing the base metal results in a base metal oxide. The oxidation, in some embodiments, can result in a modification of the metallic nanoparticles such that the resulting metallic nanoparticles appear black, dull or blackened. In one embodiment, the oxidizing agent applied to the base metal-plated substrate can comprise Ag+ such that applying Ag+ to the metal nanoparticles can result in a precipitation of silver and a dissolvation of the metal plating. In some embodiments, the oxidizing agent can be any sulfate able to oxidize the base metal applied to the substrate and cured metallic nanoparticles. In another embodiment, a sulfurizing agent can be applied to the base metal-plated substrate to cause a precipitation of a dark metal sulfide.

In still other embodiments, the method 200 can further include pre-curing or post-curing drying steps. These additional drying steps, in some embodiments, enhance the formation of a continuous, conductive shielding network by removing any excess aqueous species, i.e. the aqueous solution or medium. In some embodiments, additional post-curing drying steps can include a plasma treatment, oxidation via the application of gas, oxidation via application of electricity, or oxidation via the application of a chemical solution. Further pre-curing or post-curing steps can include applying to the substrate or to the deposited metallic nanoparticles a protective coating such as a film, resin, polymer, or additional substrate.

In one embodiment, a post-cure process can include applying a protective film to the deposited metallic nanoparticles such that it covers the metallic nanoparticles. In one embodiment, the film is applied in a manner substantially similar to lamination. Embodiments may include a protective film that can comprise any of the following materials: polyethylene; polypropylene or any other material able to be applied over the deposited metallic nanoparticles and able to provide a level of protection to the cured metallic nanoparticle structure. Still other embodiments include those utilizing a protective film comprised of a material having a T_{g} that indicates the material can be used in a lamination process; while in other embodiments the protective film is comprised of a material able to be applied via an adhesive. Still other embodiments include applying a protective film that is static dissipative such that the composite film, substrate and metallic ink deposition can dissipate static electricity. The protective film, in other embodiments, is thin and inexpensive.

In some embodiments, the method 200 can further include depositing the composition onto a first substrate and heating the composition at a temperature of less than about 140 degrees Celsius to create a cohesive metallic shielding structure having a sheet resistance less than approximately 50 mohms/square/mil. These embodiments can further include affixing the first substrate to a second substrate by laminating, gluing, bonding or otherwise affixing the first substrate to a second substrate. In further embodiments, the first substrate can be affixed to the second substrate either adhesively, cohesively or electrostatically. While the above-described embodiments contemplate two substrates affixed to one another, in other embodiments two or more substrates can be affixed to one another.

Once either the first substrate is affixed to the second substrate, or the second substrate is affixed to the first substrate; the two substrate composition can be heated via any of the curing methods described herein. The composition, in one embodiment, can be heated at a temperature of less than about 140 degrees Celsius to create a cohesive metallic shielding structure having any of the sheet resistances described herein. Upon affixing one or more additional substrates to the first substrate and curing the multiple substrate composition, the method 200 can further comprise applying any of the above-described pre-curing or post-curing drying or protection processes.

### Examples

### Example 1

An ink composition was prepared by adding 0.44 grams of a 25 wt. % polyvinyl alcohol solution (Aldrich 9,000-10,000 Mw) and 1.14 grams of an acrylic nanoparticle latex dispersion to 22.2 grams of 35 wt % silver nanoparticle dispersion. The materials were mixed well together and a film of the resulting ink was deposited onto 0.005 inch (5 mil) thick polyester film with a 0.0003 inch (0.3 mil) diameter wire wound rod and then heated at 130 degrees Celsius for 30 seconds resulting in a cohesive and conductive silver film. The adhesion of the film to the substrate was tested by applying a 4″ long strip of Scotch brand tape (3M Corporation) to the film, insuring good adhesion to the film by applying pressure with the index finger (not the fingernail). The tape is then rapidly removed, pulling upward at a 90 degree angle, perpendicular to the substrate. This tape test method is derived from the ASTM D3359-02 Standard Test Method for Measuring Adhesion by Tape Test. The result of the tape test was that only some of the cohesive and conductive silver film was removed from the substrate.

### Example 2

A composition comprising an aqueous suspension of silver nanoparticles (approximately 42 wt % silver) was mixed with 3 wt % polyvinyl alcohol (PVOH) solution (25 wt % PVOH). The samples were dried at 80 degrees Celsius for 5 minutes to 15 minutes. These samples exhibited sheet resistances of 30-45 mohms/sq at an estimated thickness of 1.5 microns. The normalized sheet resistance (per 25.4 microns or per 1 mil) was approximately 1.8 mohms/sq/mil.

| | | | D | E | F | G |
|---|---|---|---|---|---|---|
| | | C | Coverage | Sheet | Thickness, | Sheet |
| A | B | Coverage | sq m/kg | Resistance | micrometers | Resistance |
| Material | Wt % Ag | sq m/kg | @ 1 mil | mohms/sq | (estimated) | mohms/sq/mil |
| A1 | 41 | 55 | 6.50 | 129 | 3 | 7 |
| A2 | 41 | 31.7 | 6.24 | 57 | 5 | 5 |
| Comparative | 47 | 7.11 | 3.36 | 25 | 12 | 25 |
| Material 1 | | | | | | |
| Comparative | 50.8 | 4.69 | 4.62 | 15 | 25 | 15 |
| Material 2 | | | | | | |

As is seen in Table 1, inventive materials A1 through A2 exhibit certain characteristics that differentiate them from tested existing materials Comparative Material 1 and 2.

First, the inventive materials are capable of covering, on a per-weight basis, a greater surface area of substrate than are the tested existing materials, as is seen in Columns C and D of Table 1.

Second, the inventive materials exhibit a lower sheet resistance than do the tested existing materials. This is shown in Column E of Table 1. As seen in Column F of Table 1, the inventive materials achieve such sheet resistance at lower thicknesses than do the tested comparative materials. As a result, the inventive materials present lower sheet resistance on a per-thickness basis than do the tested comparative materials, as shown in Column G of Table 1.

Accordingly, as shown in Table 1, the inventive materials are capable of providing a lower sheet resistance on a per-thickness and per-area basis than are the tested comparative materials. Because the inventive materials are capable of covering, on a per-weight basis, a greater surface area of substrate than are the tested existing materials, a given weight of the inventive materials provides higher shielding coverage for a given surface area of substrate than a greater weight of the tested comparative materials.

### Example 3

To test the described structure's effectiveness for shielding, a formulation prepared according to the disclosed methods was sprayed onto the surface of polyester film and cured at 130 degrees Celsius for 1 minute. The silver coating was estimated to be 1.5 micrometers thick, and the sheet resistivity was measured to be 0.080 ohms/square at the coating thickness of 1.5 micrometers. A bag, 10 cm by 15 cm, was fashioned by folding over silver coated polyester film having metal on the inside. Opposing surfaces adjacent to the fold were heat sealed together. A cell phone was then placed inside bag, and the bag was completely sealed.

Before placing the cell phone in the bag, the cell phone signal strength was 4 bars, according to the cell phone's signal strength meter. The silver coating thickness was thin enough to allow the cell phone display to be seen through the metal/substrate matrix.

After placing the cell phone in the bag, the bag was completely sealed. Upon sealing the bag, the cell phone signal strength showed zero bars. An attempt was then made to call the cell phone, but no connection was made. When one end of the bag was reopened, the cell phone signal strength returned to 4 bars, and calling the cell phone resulted in a connection.

### Example 4

To further test the shielding effectiveness of the disclosed formulations, a procedure similar to that of Example 3 was followed. A formulation made according to the disclosed methods was sprayed onto a polyester film and cured at 130 degrees Celsius for approximately 1 minute. The silver coating was estimated to be 0.5 micrometers thick, and the sheet resistivity was measured to be approximately 0.30 ohms/square at the coating thickness of 0.5 micrometer. A bag, 10 centimeters by 15 centimeters, was fashioned by folding silver coated polyester film with the metal on the inside. The opposite surfaces adjacent to the fold were heat sealed together. A cell phone was placed inside bag, and the bag was completely sealed.

Prior to placing the cell phone in the bag, the cell phone signal strength was noted to be 4 bars. The silver coating thickness was thin enough to allow the cell phone display to be seen through the metal/substrate matrix.

After placing the cell phone in the bag, the bag was completely sealed. Upon sealing the bag, the cell phone's signal strength meter showed one bar of signal strength. An attempt was made to call the cell phone, and a connection was made. One end of the bag was opened and the cell phone signal strength returned to 4 bars. Although calling the cell phone resulted in a connection and therefore a weak signal, the bag effectively reduced the signal's strength without completely stopping the signal.

### Example 5

One exemplary method of depositing the metallic nanoparticle-based ink onto the substrate includes depositing the ink such that the substrate can function similar to that of a Faraday cage. The ink is deposited in a pattern such that the substrate remains substantially transparent. Further, the ink is deposited such that the substrate can be “hard creased” while still allowing substantially all sections of the substrate to continue providing shielding against EMI/RFI and static electricity. Thus, should the substrate be formed into a bag, the contents of the bag can be clearly seen, including markings (i.e. barcodes) on the bag contents.

In one embodiment, a repository is created from the substrate. The repository, in one embodiment, can be a bag created by folding the combined substrate, deposited ink and applied protective film in half, and heat sealing opposite ends to form a bag. Some embodiments include the creation of a repository able to be folded and creased without causing the creation of “hot spots,” or without causing a reduction in the repositories ability to perform any one of the following functions: EMI shielding; RFI shielding; and static electricity shielding.

### Example 6

Utilizing the ink composition described in Example 1, fine lines approximately 45 microns in width and lines spaced apart by a distance of approximately 300 microns, were flexographically printed in a square grid pattern onto a 5 mil print-treated polyester. The resulting lines were cured using a combination IR and convection oven at a temperature of approximately 120 degrees Celsius for no more than 5 seconds in the hot zone of the oven. The resulting pattern had a sheet resistance of 0.95 ohms/sq. The adhesion of the film to the substrate was evaluated by utilizing the previously-described tape test method. The optical transmissivity was measured to be 75%.

### Example 7

Utilizing an ink composition similar to the ink composition described in Example 1, but concentrated to a higher weight percentage metal so that the ink had a consistency similar to that of a paste rather than a consistency of a less viscous, flowable metallic dispersion of nanoparticles; fine lines of ink were printed by letterpress in a square grid pattern onto a 5 mil print-treated polyester. The printed lines had a width of approximately 25 microns and each line was separated by a distance of approximately 325 microns. The printed lines were heated to a temperature of approximately 140 degrees Celsius for no longer than one minute. The printed lines were heated using a convection oven, and they were heated in a hot zone of the oven. The resulting pattern had a sheet resistance of approximately 2 ohms/sq. The adhesion of the film to the substrate was evaluated by utilizing the tape test method previously described and the adhesion was determined to be near perfect. The optical transmissivity of the resulting film was estimated to be between 75% and 90%.

What is claimed is:

1. A metallic nanoparticle shielding structure comprising:
a substrate; and
a plurality of metallic nanoparticles deposited in a pattern on the substrate, wherein the plurality of metallic nanoparticles and the substrate are heated to a temperature less than 110 degrees Celsius to form a metallic nanoparticle shielding structure.

2. The metallic nanoparticle shielding structure of claim 1, wherein the pattern comprises at least two marks separated laterally by a space having a width of 100 to 300 micrometers, each mark having a characteristic predetermined length and a characteristic width of 20 to 40 micrometers.

3. The metallic nanoparticle shielding structure of claim 1, wherein the plurality of metallic nanoparticles comprise at least one silver nanoparticle.

4. The metallic nanoparticle shielding structure of claim 1, wherein the substrate comprises any one of a polyester substrate, a polycarbonate substrate, a liquid crystal display substrate, glass, silica-based substrate, metal substrate and metal oxide substrate.

5. The metallic nanoparticle shielding structure of claim 1, wherein the metallic nanoparticles and the substrate are heated for a period of time less than 90 seconds.

6. The metallic nanoparticle shielding structure of claim 1, wherein the plurality of metallic nanopartices have an average particle size of less than 100 nm.

7. The metallic nanoparticle shielding structure of claim 1, wherein the metallic nanoparticle shielding structure has a sheet resistance of less than 1.5 ohms/square/mil.

8. The metallic nanoparticle shielding structure of claim 1, wherein the metallic nanoparticle shielding structure further results from oxidation of a metallic plating applied to the substrate subsequent to heating the deposited metallic nanoparticles and the substrate.

9. The metallic nanoparticle shielding structure of claim 1, wherein the metallic nanoparticles are deposited in a pattern comprising a coating.

10. The metallic nanoparticle shielding structure of claim 1, wherein the metallic nanoparticles are deposited in a pattern comprising a plurality of lines.

11. A method for producing a metallic nanoparticle shielding structure, the method comprising:
depositing a plurality of metallic nanoparticles in a pattern on a substrate; and
heating the substrate and metallic nanoparticles to a temperature less than 110 degrees Celsius to form a metallic nanoparticle shielding structure.

12. The method of claim 11, wherein depositing further comprises depositing the plurality of metallic nanoparticles in a pattern comprising at least two marks separated laterally by a space having a width of 100 to 300 micrometers, each mark having a characteristic predetermined length and a characteristic width of 20 to 40 micrometers.

13. The method of claim 11, wherein depositing a plurality of metallic nanoparticles further comprises depositing the plurality of metallic nanoparticles comprising at least one silver nanoparticle.

14. The method of claim 11 wherein depositing on the substrate further comprises depositing on a substrate comprising any one of a polyester substrate, a polycarbonate substrate, a liquid crystal display substrate, and a glass substrate.

15. The method of claim 11 wherein heating further comprises heating for a period of time less than 90 seconds.

16. The method of claim 11 wherein the metallic nanopartices have an average particle size of less than 100 nm.

17. The method of claim 11, wherein the metallic nanoparticle shielding structure has a sheet resistance of less than 1.5 ohms/square/mil.

18. The method of claim 11, further comprising:
applying, after heating the metallic nanoparticles and the substrate, a metallic plating to the substrate and the metallic nanoparticles; and
oxidizing the metallic plating to remove the metallic plating.

19. The method of claim 11, wherein the pattern comprises a coating.

20. The method of claim 11, wherein the pattern comprises a plurality of lines.
